(19) United States
(12) Patent Application Publication
(10) Pub. No.: US 2005/0184247 A1
(43) Pub. Date: Aug. 25, 2005

(54) Device for measuring angular distribution of EUV light intensity, and method for measuring angular distribution of EUV light intensity

(75) Inventors: Jun Ito, Utsunomiya-shi (JP); Hajime Kanazawa, Utsunomiya-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/054,834

(22) Filed: Feb. 10, 2005

(30) Foreign Application Priority Data
Feb. 20, 2004 (JP) 2004-044723

(51) Int. Cl. G01J 1/42

(52) U.S. Cl. 250/372

(57) ABSTRACT

An EUV light intensity distribution measuring device for measuring the angular distribution of intensity of EUV light emitted from an EUV light source. The EUV light has a center point of divergence. The EUV light intensity distribution measuring device includes a plurality of first EUV light detecting units. These units are movably disposed at different positions on a substantially spherical plane centered on the center point of divergence of the EUV light so as to allow at least adjacent first EUV light detecting units to detect EUV light at a substantially same position on the spherical plane. Thus, an EUV light intensity distribution measurement device and an EUV light intensity distribution measurement method, capable of precisely measuring the angular distribution of the intensity within the EUV light emitted from the EUV light source are provided.

### BACKGROUND OF THE INVENTION

1. Field of the Invention

The present invention relates to a device and method for evaluating properties of an EUV (Extreme Ultraviolet) light source used with projection exposure apparatuses and the like. Particularly, the present invention relates to an EUV light intensity distribution measurement device, and to an EUV light intensity distribution measurement method used with the measurement device.

2. Description of the Related Art

Conventionally, reduction projection exposure employing ultraviolet rays has been used as the exposure process in lithography for manufacturing fine semiconductor devices such as semiconductor memory, logic circuits, and the like. The smallest dimension which can be transferred with reduction projection exposure is proportional to the wavelength of the light used for transfer, and inversely proportional to the number of openings of the projection optical system. Accordingly, types of light with shorter wavelengths have come to be used for transferring such fine circuit patterns, such as mercury lamp i-line (wavelength 365 nm), KrF excimer laser (wavelength 248 nm), and ArF excimer laser (wavelength 193 nm).

However, semiconductor devices are rapidly becoming finer, and there is a limit to lithography using ultraviolet light. Accordingly, a reduction projection exposure device using EUV (Extreme Ultraviolet) light around 10 to 15 nm in wavelength, which is even shorter than ultraviolet rays, has been developed for exposing extremely fine circuit patterns smaller than 0.1 μm. FIG. 13 is a conceptual diagram of the EUV exposure device.

In parallel with development of this reduction projection exposure device, an EUV light source to be used therein has been developed. For example, Japan Patent Laid-Open No. 2002-174700 (corresponding U.S. Pat. No. 6,324,256) discloses a laser plasma light source. This arrangement involves irradiating high-intensity pulse laser beams at a target material placed within a vacuum container, thereby generating high-temperature plasma which services as a light emission point, and EUV light with a wavelength of around 13 nm, for example, emitted therefrom is used. Target materials used include metal thin film, inert gas, liquid droplets, and so forth, and is supplied into the vacuum container by means such as a gas jet or the like. In order to raise the average intensity of the EUV light emitted from the target, the repetition frequency of the pulse laser is increased, and normally is operated at a frequency of several kHz. Also, an optical device is provided for efficiently using the EUV light emitted from the target.

The optical devices making up the exposure device using EUV light include grazing incidence total reflection mirrors and near normal incidence mirrors, which are multilayer mirrors formed with a multilayer including silicon and molybdenum. The near normal incidence multilayer mirror has high reflectance with regard to EUV light with a wavelength of 13.5 nm. Consequently, of the light emitted from the EUV light source, EUV light within a range of 13.365 nm to 13.635 nm, centered on the wavelength 13.5 nm, is used for projection exposure. The EUV light from the point of light emission is collected at a convergence point by a collecting mirror. Following divergence from the convergence point, the light is introduced to the projection exposure device, where a mask is uniformly irradiated with an illumination optical system of the projection exposure device.

Uniformly irradiating the mask is extremely crucial to the capabilities of the projection exposure device, such as resolution. The intensity of the EUV light diverging from the convergence point should also be uniform within the divergence angle thereof. However, the EUV light diverging from the convergence point is not necessarily irradiated at a uniform intensity within the divergence angle, due to factors such as the shape of the plasma, distribution of gas concentration within the vacuum contained, shape of the collection mirror, and so forth. As such, there is the need to understand the intensity distribution within the divergence angle of the EUV light source beforehand, and correct non-uniformities with the illumination optical system.

Achieving the above necessitates a device for measuring the angular distribution of the intensity of EUV light (hereafter may be simply referred to as “angular distribution”), and this angular distribution can be measured with a device such as shown in FIG. 12, which is disclosed in Japanese Patent Laid-Open No. 2002-175980 (corresponding U.S. patent application No. 20020085286). Note that the term “angular distribution of intensity of EUV light” as used in the present specification means the distribution of intensity according to emission angle (emission direction) of the EUV light emitted from the EUV light source. In FIG. 12, reference numeral 101 denotes a divergence point where light including the EUV light diverges. The light diverging from the divergence point 101 reflects off of a mirror 102 and further passes through an EUV filter 103 which only transmits EUV light, so that only the EUV light reaches a CCD array 104. Although the EUV light from the divergence point 101 reaches different points on the CCD array 104 according to the angle of divergence, the angular distribution of the EUV light at the divergence point 101 can be known by the output of each position on the CCD.

However, measuring the angular distribution with the above-described device of FIG. 12 has the following problems.

One point is that a multilayer mirror is normally used as an EUV light mirror in a case such as shown in FIG. 12 wherein the mirror is not a grazing incidence total reflection mirror. However, wavelengths at which the reflectance is the greatest differs according to incident angle. Accordingly, there is sensitivity to the EUV light with different wavelengths according to the position on the CCD acceptance surface. This means that the angular distribution of EUV light cannot be accurately obtained over the wavelength range of 13.365 nm through 13.635 nm used for projection exposure.

The second point is that the multilayer mirror and detector and the like are usually pre-calibrated. However, scattering particles called debris are generated along with the EUV light from the light source, which contaminate and damage the multilayer mirror, leading to deterioration in the reflectance of the mirror. Also, contamination of the atmosphere within the chamber results in contaminants being deposited on the surface of the photoelectric converter, consequently changing the sensitivity of the CCD. This means that the angular distribution of the EUV light cannot be accurately obtained.

### SUMMARY OF THE INVENTION

The present invention is directed to an EUV light intensity distribution measurement device capable of precisely measuring angular distribution of intensity within an EUV light flux emitted from an EUV light source, and an EUV light intensity distribution measurement method.

To this end, according to one aspect of the present invention, a device is operable to measure angular distribution of intensity of EUV light emitted from an EUV light source. The EUV light has a center point of divergence. The device includes a plurality of first EUV light detecting units that are movably disposed at different positions on a substantially spherical plane centered on the center point of divergence of the EUV light so as to allow at least adjacent first EUV light detecting units to detect the EUV light at a substantially same position on the spherical plane.

According to another aspect of the present invention, an EUV light intensity distribution measuring device is operable to measure intensity distribution within an EUV light flux emitted from an EUV light source. The EUV light flux having a center point of divergence. The measuring device includes a plurality of first EUV light detecting units having an EUV light reflecting mirror and a photoelectric conversion device. The first EUV light detecting units are movably disposed at different positions on a substantially spherical plane centered on the center point of divergence of the EUV light flux. The plurality of first EUV light detecting units include a first group of first EUV light detecting units movable to a reference position on a substantially spherical plane, and a second group of first EUV light detecting units restricted from moving to the reference position. The second group of first EUV light detecting units and at least one of the first EUV light detecting units of the first group are configured to detect the EUV light flux at a substantially same position on the spherical plane.

According to yet another aspect of the present invention, an EUV light intensity distribution measuring device is operable to measure intensity distribution within an EUV light flux emitted from an EUV light source. The EUV light flux has a center point of divergence. The measuring device includes a plurality of first EUV light detecting units having an EUV light reflecting mirror and a photoelectric conversion device. The detecting units are movably disposed at different positions on a substantially spherical plane centered on the center point of divergence of the EUV light flux. The plurality of first EUV light detecting units are configured to move to a reference position on the spherical plane.

As described above, in the EUV light intensity distribution measuring device, multiple EUV light detecting units including the reflecting mirror and the photoelectric conversion device are disposed at differing positions but approximately at the same distance from the center point of divergence of EUV light. The EUV light detecting units are configured so as to be capable of moving over the spherical plane centered on the center point of divergence of the EUV light so as to be capable of detecting EUV light intensity from arbitrary angular directions, whereby the angular distribution of only EUV light only within a desired wavelength range can be accurately obtained. Further, the change of EUV light angular distribution over time can be measured.

Further, in the EUV light intensity distribution measuring device, multiple EUV light detecting units can be calibrated, so calibrating the multiple EUV light detecting units each with different sensitivity beforehand allows highly precise angular distribution to be obtained.

Further features and advantages of the present invention will become apparent from the following description of exemplary embodiments with reference to the attached drawings.

### BRIEF DESCRIPTION OF THE DRAWINGS

FIG. 1 is a cross-sectional diagram illustrating an EUV light intensity distribution measuring device according to a first embodiment of the present invention.

FIG. 2 is a view of the EUV light intensity distribution measuring device shown in FIG. 1 from arrows A-A therein.

FIG. 3 is a cross-sectional diagram illustrating the configuration of an EUV detecting unit.

FIG. 4 is a graph illustrating angular distribution.

FIG. 5 is a graph illustrating measurement results.

FIG. 6 is a cross-sectional diagram illustrating an EUV light intensity distribution measuring device according to a second embodiment of the present invention.

FIG. 7 is a view of the EUV light intensity distribution measuring device shown in FIG. 6 from arrows A-A therein.

FIG. 8 is a cross-sectional diagram illustrating an EUV light intensity distribution measuring device according to a third embodiment of the present invention.

FIG. 9 is a view of the EUV light intensity distribution measuring device shown in FIG. 8 from arrows A-A therein.

FIG. 10 is a graph illustrating an example of incident angle-reflectance properties of a multilayer mirror in the third embodiment of the present invention.

FIG. 11 is a graph illustrating an example of sensitivity of a photodiode in the third embodiment of the present invention.

FIG. 12 is a diagram illustrating a conventional example.

FIG. 13 is a diagram illustrating a conventional example.

### DESCRIPTION OF THE EMBODIMENTS

The present invention will now be described by way of various embodiments.

### First Embodiment

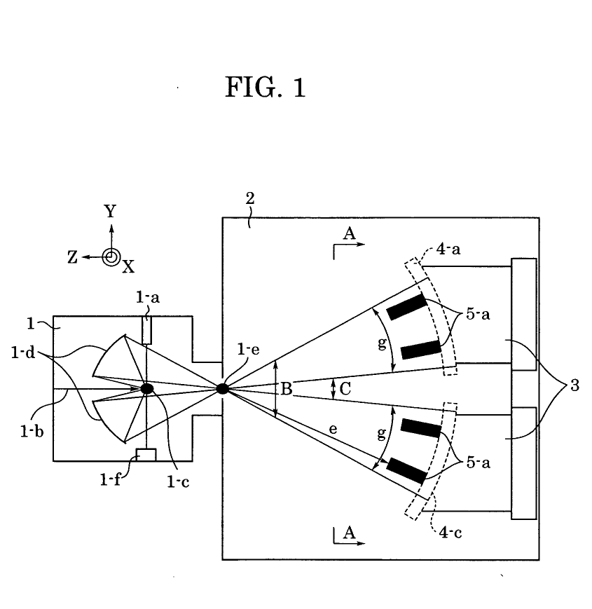

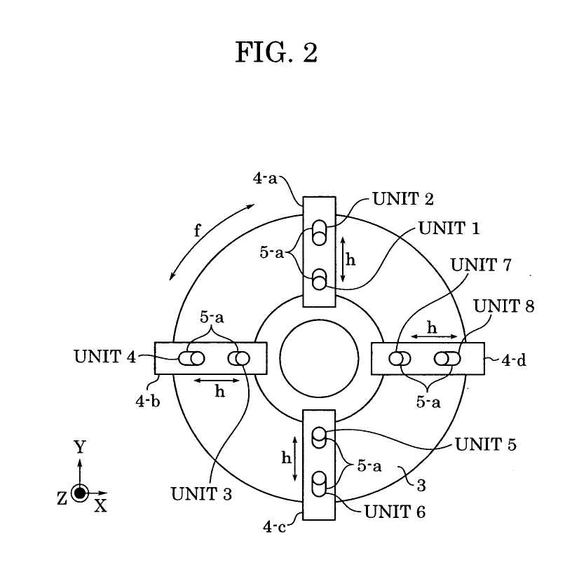

FIG. 1 shows a cross-sectional diagram of an EUV light intensity angular distribution measuring device according to the first embodiment, and the EUV light source for generating the EUV light which is to be measured. FIG. 2 is a view along arrows A-A in FIG. 1. In the following description of the invention, coordinates axes will be employed wherein the direction perpendicular to the drawing in FIG. 1, i.e., the direction toward the viewer, is the X axis, the vertical direction in the drawing is the Y axis, and the horizontal direction in the drawing is the Z axis. In the present embodiment, description will be made regarding a case of applying the EUV light intensity distribution measuring device according to the present embodiment with regard to an EUV light source which collects EUV light primarily diverging from a light emission point to a convergence point using a collecting mirror having a rotational elliptical face, and supplying the light to a projection exposure device. The same advantages can be obtained by an arrangement applying the present invention to an EUV light source which supplies the EUV light diverging from a light emission point to a projection exposure device as parallel rays using a collection mirror having a rotational parabolic face, by changing the configuration of the device corresponding to change in the EUV light flux as appropriate.

An EUV light source 1 irradiates a pulse laser beam 1-b to a target material (Xenon) supplied from a nozzle 1-a, thereby forming plasma of the target material near the light emission point 1-c, emitting pulsing EUV light. Reference numeral 1-f denotes a mechanism for collecting the target material. The pulsing EUV light is collected by a collecting mirror 1-d at a convergence point 1-e, and the EUV light is diverged toward within a solid angle B excluding a solid angle C, with the convergence point 1-e as the center point of divergence.

An EUV light intensity distribution measuring device 2 according to the present embodiment has θ stages 4-a through 4-d capable of centrally rotating around the convergence point 1-e within a plane including the Z axis, the θ stages 4-a through 4-d having been provided on a ωZ stage 3 capable of centrally rotating around the convergence point 1-e on the Z axis. Further, two EUV light detecting units 5-a are provided on each of the θ stages 4-a through 4-d. The θ stages 4-a through 4-d are formed arc-shaped so as to be on the same circle with the same radius to the center which is the convergence point 1-e as illustrated in FIG. 1, so all of the EUV light detecting units 5-a are at positions e which are at equal distances from the convergence point 1-e.

According to such a configuration, all of the EUV light detecting units 5-a are capable of rotating around the Z axis indicated by arrow f in FIG. 2 by the ωZ stage 3, and also are capable of centrally rotating around the convergence point 1-e within a plane including the Z axis as indicated by arrows g in FIG. 1, i.e., arrows h in FIG. 2, by the θ stages 4-a through 4-d.

Due to such a configuration, the multiple EUV light detecting units 5-a are disposed at different positions which are approximately the same distance from the convergence point 1-e, and the EUV light detecting units 5-a are capable of moving over a spherical plane centered on the convergence point 1-e, so the EUV light intensity in an arbitrary angular direction can be detected. Note that EUV light has a nature of being absorbed by gasses, and accordingly, the interior of the EUV light intensity distribution measuring device 2 is maintained in a vacuum by evacuating with an unshown vacuum evacuating system in order to prevent such absorption.

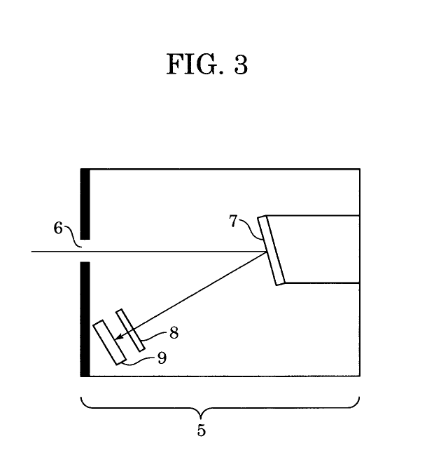

FIG. 3 is a cross-sectional diagram illustrating the configuration of a EUV light detecting unit 5-a. The multiple EUV light detecting units provided within the EUV light intensity distribution measuring device 2 all have the same configuration. EUV light entering the EUV light detecting unit 5-a from an aperture 6 is reflected off a multilayer mirror 7, which is a reflecting mirror typically configured of a multilayer film of silicon and molybdenum, and then passing through a thin-film filter 8 of zirconium, for example, set so as to absorb wavelengths other than EUV light if necessary. The intensity is measured by a photodiode 9 which is a photoelectric conversion device. Alternatively, a CCD which effects spatial resolution may be used to realize the same effects, instead of the photodiode 9. Signals are output from the photodiode 9 according to the intensity of the EUV light, which is the output of the EUV light detecting unit 5-a. Also, an arrangement may be made wherein an amplifier unit is provided to the EUV light detecting unit 5-a in the event that the output signals are weak to the extent necessitating such an arrangement, whereby output from the photodiode 9 is amplified and taken as the output of the EUV light detecting unit 5-a.

The multilayer mirror 7 is configured with silicon layers and molybdenum layers being alternately formed by a known technique, to thicknesses where reflectance of EUV light having a wavelength of about 13.5 nm which is used for projection exposure becomes maximal. Also, in some cases, a layer may be provided for alleviating the surface coarseness of the interface between the silicon layer and molybdenum layer. The light from the EUV light source 1 includes not only EUV light of a wavelength about 13.5 nm which is used for projection exposure, but also includes EUV light with a wavelength of about 10 to 20 nm, longer wavelength ultraviolet rays, visible rays, and infrared rays. In the event that all such light were cast onto the photodiode 9, measuring the EUV intensity distribution actually used for exposure would be difficult. However, reflecting the light off of the multilayer mirror 7 such as described above removes the rays other than the EUV light having the wavelength about 13.5 nm, and consequently the intensity distribution of the intended EUV light can be measured. In the event of performing measurement with even higher precision, the filter 8 for absorbing light other than the intended EUV light (e.g., a Zr filter) is provided in the optical path.

Also, the output of the EUV light detecting unit 5-a is signals corresponding to the intensity of the EUV light around the wavelength 13.5 nm regardless of the proportion of the polarization component, with the incident angle to the multilayer mirror 7 set to about 10°, which is near normal incidence. Note that the incident angle is not restricted to 10°, and that an angle of 20° or smaller may be used so long as there is no great difference between the reflectance of s polarization and p polarization.

Due to the above-described configuration, the EUV light intensity distribution measuring device 2 is capable of measuring the intensity of EUV light in an arbitrary direction, and the angular distribution of the EUV light intensity of the wavelength used for projection exposure, diverging from the convergence point 1-e, can be obtained.

With the present embodiment, the EUV light intensity distribution is measured using multiple EUV light detecting units, so obtaining the sensitivity of each EUV light detecting units beforehand by measuring EUV light of a known intensity and obtaining the output of the measurement thereof, for example, can provide precise measurement of the intensity distribution within the EUV light flux.

However, the EUV light source generates flying particles called debris along with the EUV light, and there is a problem that the sensitivity of the EUV light detecting units change due to this. Specifically, the debris soils and damages the multilayer mirror, resulting in deterioration of the reflectance of the mirror. Also, contamination of the atmosphere within the chamber, including debris, results in contaminants being deposited on the surface of the photoelectric converting device, changing the sensitivity of the photoelectric converting device. As a result, the sensitivity of the EUV light detecting unit changes, leading to a problem that measurement cannot be precisely made.

Accordingly, with the present embodiment, a method will be described wherein multiple EUV light detecting units are assembled into the EUV light intensity distribution measuring device 2, and in this state, the ratio of sensitivity thereof is found to enable precise measurement of intensity distribution.

Procedures will now be described for calibrating each of the EUV light detecting units 5-a of the EUV light intensity distribution measuring device 2 containing eight EUV light detecting units 5-a as shown in FIG. 2, in a state wherein the EUV light detecting units 5-a remain in the EUV light intensity distribution measuring device 2. As shown in FIG. 2, the EUV light detecting units 5-a on the θ stage 4 are each referred to as unit No. 1 through unit No. 8.

In step 1, the unit No. 1 is the unit of interest, and in a state that the unit No. 1 is at a predetermined angular position (φa, θa), EUV light is irradiated, thereby obtaining the output Q1(φa, θa) of the unit No. 1. Here, φ indicates the angle relating to rotation around the Z axis indicated by arrow f in FIG. 2 by the ωZ stage 3, and θ represents the angle relating to movement in the radial direction of the ωZ stage 3 by the θ stages 4-a through 4-d.

In step 2, the unit No. 2 is brought to the same angular position (φa, θa) by movement of the θ stage 4-a, and EUV light is irradiated, thereby obtaining the output Q2(φa, θa) of the unit No. 2. At this time, with the intensity of the EUV light emitted equivalent at angle (φa, θa), the output of each can be expressed as
Q2(φa, θa)=αQ1(φa, θa) (1)
wherein α is a constant, indicating the ratio of sensitivity between unit No. 1 and unit No. 2.

In step 3, with the unit No. 3 at a predetermined angular position (φb, θb), EUV light is irradiated, thereby obtaining the output Q3(φb, θb) of the unit No. 3.

In step 4, the unit No. 4 is brought to the same angular position (φb, θb) by movement of the θ stage 4-b, and EUV light is irradiated, thereby obtaining the output Q4(φb, θb) of the unit No. 4.

In step 5, the unit No. 1 is brought to the same angular position (φb, θb) by movement of the ωZ stage 3 and θ stage 4-a, and EUV light is irradiated, thereby obtaining the output Q1(φb, θb) of the unit No. 1. In steps 3 through 5, with the intensity of the EUV light emitted equivalent at angle (φa, θa), the output of each can be expressed as
Q3(φb, θb)=βQ1(φb, θb) (2)
wherein β is a constant, indicating the ratio of sensitivity between unit No. 1 and unit No. 3. Also,
Q4(φb, θb)=γQ3(φb, θb) (3)
wherein γ is a constant, indicating the ratio of sensitivity between unit No. 3 and unit No. 4. Further, from Expression (2) and (3),
Q4(φb, θb)=γβQ1(φb, θb) (4)

The ratio of output of the units Nos. 1 through 8 are obtained in the same way as described above with Expressions (1) through (4), and the sensitivity ratio as to the unit No. 1 can be obtained for all EUV light detecting units, with the output of the EUV light at each angular position being equivalent.

Also, in a case in which the EUV light irradiated from the EUV light source changes over time, such as the spectrum changing over time or the angular distribution of intensity changing over time at a certain angle (φ, θ), regarding which calibration is to be performed, for example, either the time for irradiating EUV light is sufficiently extended and the average output thereof is used, or each of the EUV light detecting units are alternately disposed at the angle (φ, θ) and measurement is repeated and the average output thereof used, whereby effects of change over time with regard to the EUV light source can be eliminated.

Accordingly, calibrating each of multiple EUV light detecting units with different sensitivity beforehand allows the angular distribution of EUV light intensity to be obtained with higher precision. Also, this calibration operation can be performed without removing the EUV light detecting units from the device, so change in sensitivity of the EUV light detecting units following measurement can be checked.

With the EUV light intensity distribution measuring device 2 according to the present embodiment, the multiple EUV light detecting units 5-a are disposed at equal distances form the convergence point 1-e, so intensity measurement of EUV light of a predetermined wavelength can be made at an equivalently-corrected sensitivity regardless of the angle of the EUV light emitted from the convergence point 1-e, and as a result, measurement of intensity distribution within the EUV light flux emitted from the convergence point 1-e can be performed with high precision. Also, the EUV light flux can be scanned with a single EUV light detecting unit 5-a facing the convergence point 1-e, realizing measurement of angular distribution of intensity in the same way as with using the multiple light detecting units 5-a as described in the present embodiment. On the other hand, in the event that the target material is a gas or liquid in particular, there are cases wherein the distribution of the EUV light generated in a pulsing manner at the light emission point 1-c differs from one pulse to another. The time of one pulse light emission is extremely short, about 1 msec or shorter. So in the event that the intensity distribution is measured by scanning the EUV light detecting units 5-a, the irregularity in distribution of EUV light from one pulse to another becomes indiscernible from the true distribution, making measurement of the angular distribution of average EUV light intensity difficult. Conversely, disposing a sufficient number of EUV light detecting units 5-a within the EUV light flux to perform simultaneous measurement enables measurement of the angular distribution of EUV light intensity for each pulse and measurement of the angular distribution of average EUV light intensity.

Further, EUV light from the convergence point 1-e is input to the photodiode 9 by the EUV light detecting units 5-a, having been restricted to a narrow range by the aperture 6 having a generally circular EUV light transmitting portion. Accordingly, the extent of the incident angle to the multilayer mirror 7 is restricted, thereby enabling narrowing of the range of wavelength distribution having reflected light, consequently enabling precise intensity measurement of the EUV light having the intended wavelength. With the present embodiment, the angle viewing the convergence point 1-e from the aperture 6 of the EUV light detecting unit 5-a is set to about 6°. However, angle viewing the convergence point 1-e from the aperture 6 is not restricted to this, and good measurement results can be obtained with an angle of about 10° or smaller.

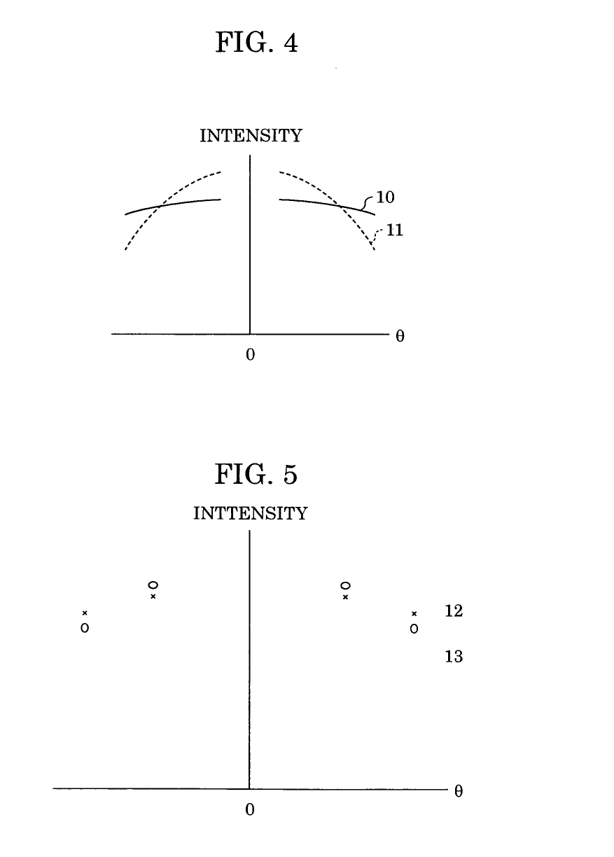

Two EUV light detecting units 5-a are disposed in the radial direction in FIG. 2, and four sets thereof in FIG. 2 in the circumferential direction, for a total of eight EUV light detecting units 5-a. By simultaneously and continuously measuring with these eight EUV light detecting units 5-a, the change over time of angular distribution can be known, even without moving the EUV light detecting units using the ωZ stage 3 or θ stages 4-a through 4-d. This will be described with FIG. 4.

FIG. 4 is a graph illustrating angular distribution, indicating the angular direction from the Z axis centered on the convergence point 1-e, and the intensity of 13.5 nm EUV light, wherein the horizontal axis shows the angle from the Z axis, and the vertical axis shows intensity. For example, in the event that the angular distribution changes over time from a state indicated by the solid line 10 in FIG. 4 to the state indicated by the dotted line 11, there will be two types of measurement results in accordance with the change in measurement results at the EUV light intensity distribution measuring device 2 according to the present embodiment, which are illustrated in FIG. 5 as x (cross) plots 12 and O (circle) plots 13. Thus, the change in angular distribution over time can be known.

Further, the multiple EUV light detection units 5-a are also disposed on the circumferential direction in FIG. 2, and accordingly, change of intensity distribution over time with circumferential direction coordinates can also be known. In order to determine the change of angular distribution over time, the placement of the EUV light detection units should be such that the center point of divergence of EUV light and all of the EUV light detection units are not positioned on the same plane.

### Second Embodiment

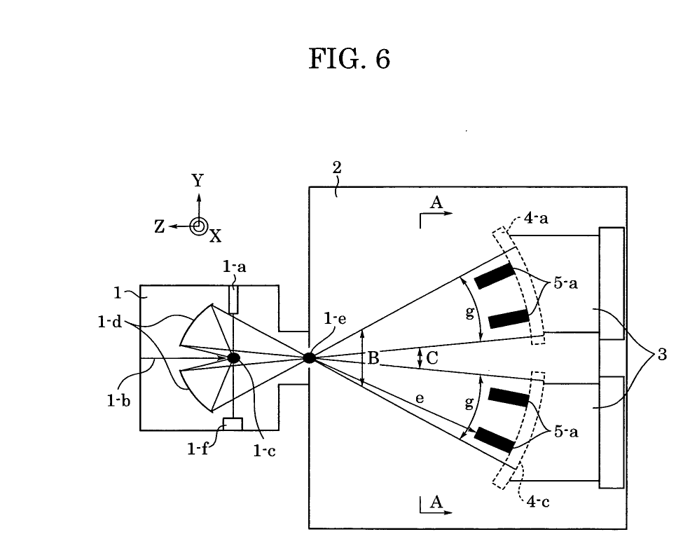

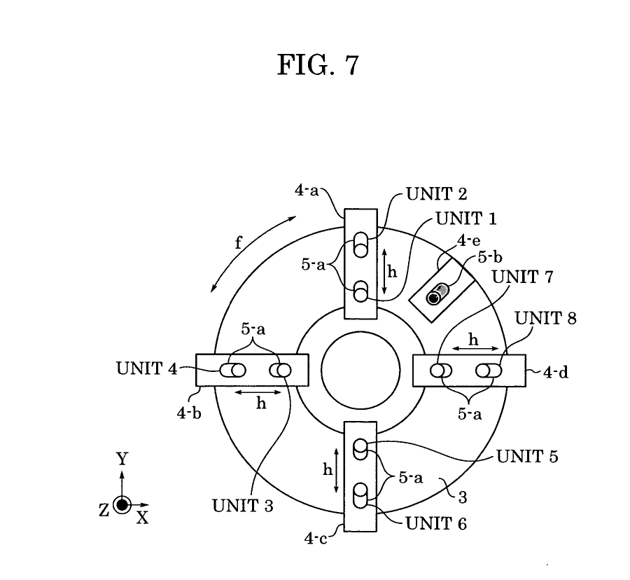

Next, a second embodiment of the present invention will be described. FIG. 6 shows a cross-sectional diagram of an EUV light intensity distribution measuring device according to the second embodiment, and the EUV light source for generating the EUV light which is to be measured. FIG. 7 is a view along arrows A-A in FIG. 6. In the following description of the invention, coordinates axes will be employed wherein the direction perpendicular to the drawing in FIG. 6, i.e., the direction toward the viewer, is the X axis, the vertical direction in the drawing is the Y axis, and the horizontal direction in the drawing is the Z axis. Note that the components shown in FIGS. 6 and 7 which are of the same configuration as those in FIGS. 1 and 2 will be denoted with the same reference numerals, and description thereof will be omitted.

With the EUV light intensity distribution measuring device 2 according to the present embodiment, in addition to the eight EUV light detecting units being disposed as with the first embodiment, one reference EUV light detecting unit 5-b is provided that is used only in the event of calibrating the EUV light detecting units. The reference EUV light detecting unit 5-b is arranged so as to be capable of moving within or out of the EUV light flux. Accordingly, the reference EUV light detecting unit is not readily soiled with debris or the like generated along with the EUV light, and thus can be used as a reference for calculating absolute sensitivity of each of the EUV light detecting units.

As shown in FIG. 7, all of the EUV light detecting units 5-a are positioned at an equal distance e from the convergence point 1-e. The EUV light detecting units 5-a on the θ stages 4a-4d are each referred to as unit No. 1 through unit No. 8. Also, with the present embodiment, description will be made regarding a case wherein the reference EUV light detecting unit 5-b is positioned at the same distance e from the convergence point 1-e as with another EUV light detecting unit 5-a, but an arrangement may be made wherein the reference EUV light detecting unit 5-b is positioned at a different distance from the convergence point 1-e.

Since multiple EUV light detecting units 5-a are used with the present embodiment as well, there is the need to obtain the sensitivity ratio of the multiple EUV light detecting units. Also, there may be cases wherein obtaining the sensitivity ratio is difficult in cases in which the intensity of emitted light from the EUV light source itself changes.

Accordingly, with the present embodiment, output Q(φ, θ) at a predetermined angular position (φ, θ) is obtained using the reference EUV light detecting unit 5-b for calibration, at the same time as measurement being performed for obtaining the sensitivity ratio among the units No. 1 through No. 8 in the same way as with the first embodiment. Accordingly, the absolute sensitivity ratio of each of the EUV light detecting units can be obtained, so that accurate sensitivity ratio measurement can be made regardless of change in emission intensity of the EUV light source.

In step 1, unit No. 1 is the unit of interest in the same way as with the first embodiment. In a state in which the unit No. 1 is at a predetermined angular position (φa, θa), EUV light is irradiated to obtain the output Q1(φa, θa) of the unit No. 1. At the same time, the output Q1(φ, θ) of the reference EUV light detecting unit 5-b fixed at a predetermined angular position (φ, θ) is obtained.

In step 2, unit No. 2 is brought to the same angular position (φa, θa) by movement of the θ stage 4-a, and EUV light is irradiated, thereby obtaining the output Q2(φa, θa) of the unit No. 2. At the same time, the output Q2(φ, θ) of the reference EUV light detecting unit 5-b fixed at the predetermined angular position (φ, θ) is obtained.

The relation of the outputs obtained thus can be expressed as
Q2(φa, θa)/Q2(φ, θ)=α′ Q1(φa, θa)/Q1(φ, θ) (5)
wherein α′ is a constant indicating the ratio of sensitivity between unit No. 1, which has been standardized by the reference EUV light detecting unit 5-b, and unit No. 2.

In step 3, with unit No. 3, which is the unit of interest, at a predetermined angular position (φb, θb), EUV light is irradiated, thereby obtaining the output Q2(φb, θb) of unit No. 3. At the same time, the output Q3(φ, θ) of the EUV light detecting unit 5-b fixed at the predetermined angular position (φ, θ) is obtained.

In step 4, unit No. 4 is brought to the same angular position (φb, θb) by movement of the θ stage 4-b, and EUV light is irradiated, thereby obtaining the output Q4(φb, θb) of unit No. 4. At the same time, the output Q4(φ, θ) of the reference EUV light detecting unit 5-b fixed at the predetermined angular position (φ, θ) is obtained.

In step 5, unit No. 1 is brought to the same angular position (φb, θb) by movement of the ωZ stage 3 and the θ stage 4-a, and EUV light is irradiated, thereby obtaining the output Q1(φb, θb) of unit No. 1. At the same time, the output Q5(φ, θ) of the reference EUV light detecting unit 5-b fixed at the predetermined angular position (φ, θ) is obtained.

The relation of the outputs obtained thus can be expressed as:
Q3(φb, θb)/Q3(φ, θ)=β′Q1(φb, θb)/Q5(φ, θ) (6)
Q4(φb, θb)/Q4(φ, θ)=γ′Q3(φb, θb)/Q3(φ, θ) (7)
β′ is a constant indicating the ratio of sensitivity between unit No. 1, which has been standardized by the reference EUV light detecting unit 5-b, and unit No. 3. Also, γ′ is a constant indicating the ratio of sensitivity between unit No. 4, which has been standardized by the reference EUV light detecting unit 5-b, and unit No. 3.

As described above, the ratio of outputs of the unit Nos. 1 through 8 are obtained by repeating these steps, and the sensitivity ratio of all the EUV light detecting units can be obtained. Also, output for a constant angular position (φ, θ) is obtained, whereby effects of intensity change of the EUV light source can be eliminated.

Accordingly, calibrating beforehand each of the multiple EUV light detecting units with different sensitivity allows the angular distribution of EUV light intensity to be obtained with higher precision. Also, this calibration operation can be performed without removing the EUV light detecting units from the device, so that change in sensitivity of the EUV light detecting units following measurement can be checked.

### Third Embodiment

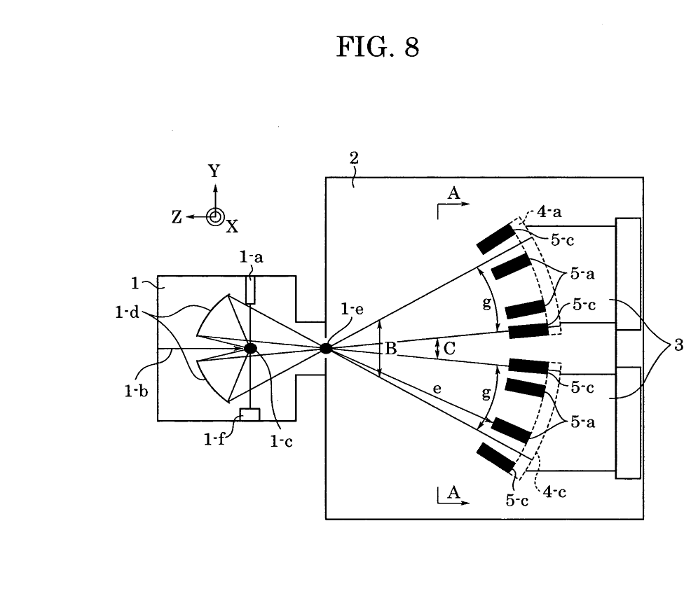

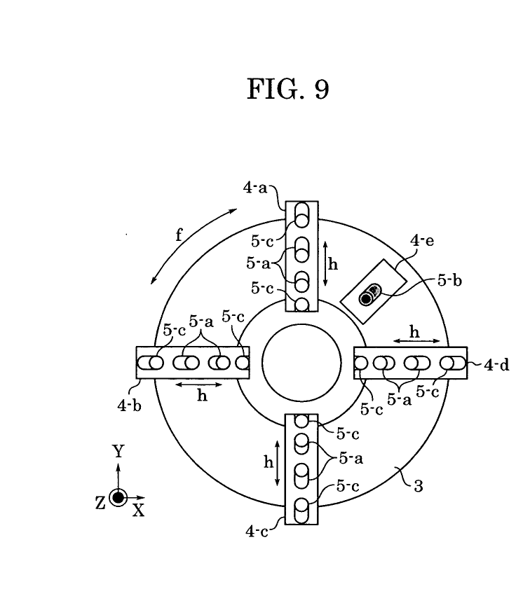

Next, a third embodiment of the present invention will be described. FIG. 8 shows an EUV light intensity distribution measuring device 2 according to the third embodiment, which has a different number of EUV light detecting units as compared with the first and second embodiments. FIG. 9 is a view along arrows A-A in FIG. 8. The EUV light intensity angular distribution measuring device 2 according to the present embodiment has θ stages 4-a through 4-e capable of centrally rotating around the convergence point 1-e within a plane including the Z axis. The θ stages 4-a through 4-d are provided on a (Z stage 3 capable of centrally rotating around the convergence point 1-e on the Z axis. Further, four EUV light detecting units, 5-a and 5-c, are provided on each of the θ stages 4-a through 4-d. Also, a reference EUV light detecting unit 5-b used only at the time of calibrating the EUV light detecting units is disposed on the θ stage 4-e, with a beam shutter (the hatched portion of 5-b) closed for normal measurements. As shown in FIG. 8, the θ stages 4-a through 4-e have an arc-shape so as to be on the same circle with the same radius to the center, which is the convergence point 1-e, so that all of the EUV light detecting units 5-a and 5-b are at positions e, which are at equal distances from the convergence point 1-e.

According to such a configuration, all of the EUV light detecting units 5-a are capable of rotating around the Z axis indicated by arrow f in FIG. 9 by the ωZ stage 3, and also are capable of centrally rotating around the convergence point 1-e within a plane including the Z axis as indicated by arrows g in FIG. 8, i.e., arrows h in FIG. 9, by the θ stages 4-a through 4-d.

With the present embodiment, description will be made regarding an arrangement wherein the EUV light detecting units 5-a are capable of moving to the same position as that of the reference EUV light detecting unit 5-b in FIG. 9 in particular, and the EUV light detecting units 5-c are capable of moving to the same position as that of the EUV light detecting units 5-a, but not to the position of the reference EUV light detecting unit 5-b. However, embodiments of the present invention are not restricted to this example, and embodiments thereof may be made regarding cases wherein all EUV light detecting units are capable of moving to the same position as that of the reference EUV light detecting unit 5-b.

The EUV light detecting units shown in FIG. 9 also need calibration as with the earlier embodiments, but the number thereof has increased over that of the first and second embodiments, so calibration of the EUV light detecting units requires more time. Also, an arrangement wherein all of the EUV light detecting units 5-a can be moved to the same position as that of the reference EUV light detecting unit 5-b so as to carry out the same calibration operations as those of the first embodiment would result in a larger measurement device.

Accordingly, with the present embodiment, procedures will be described for calibrating each of the EUV light detecting units of the EUV light intensity distribution measuring device 2, in a state wherein the EUV light detecting units remain in the EUV light intensity distribution measuring device 2.

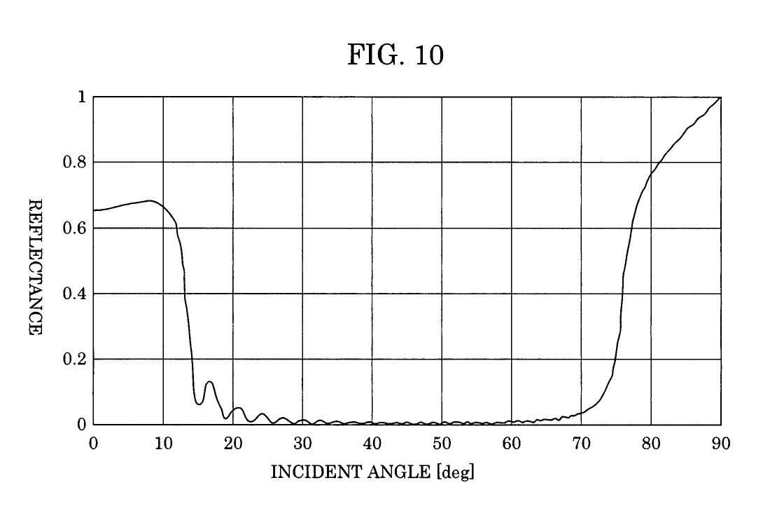

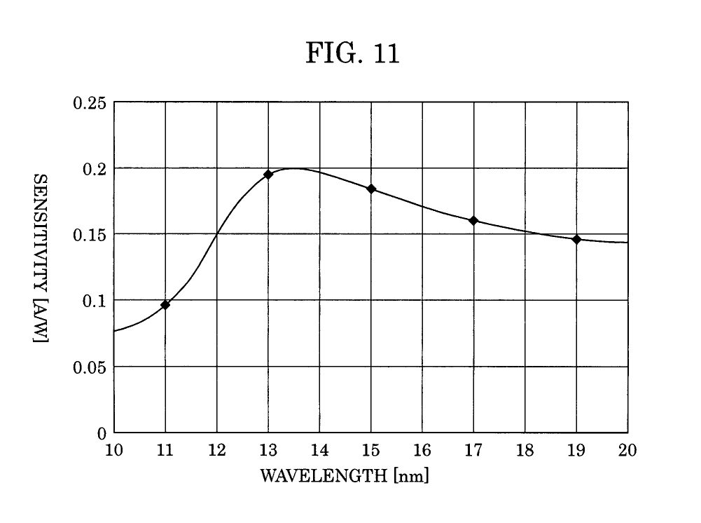

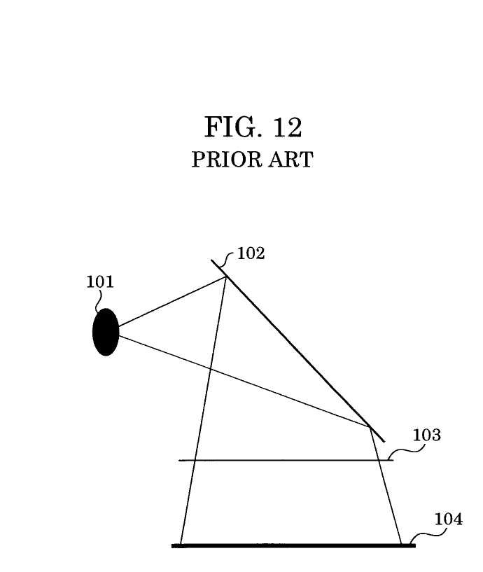

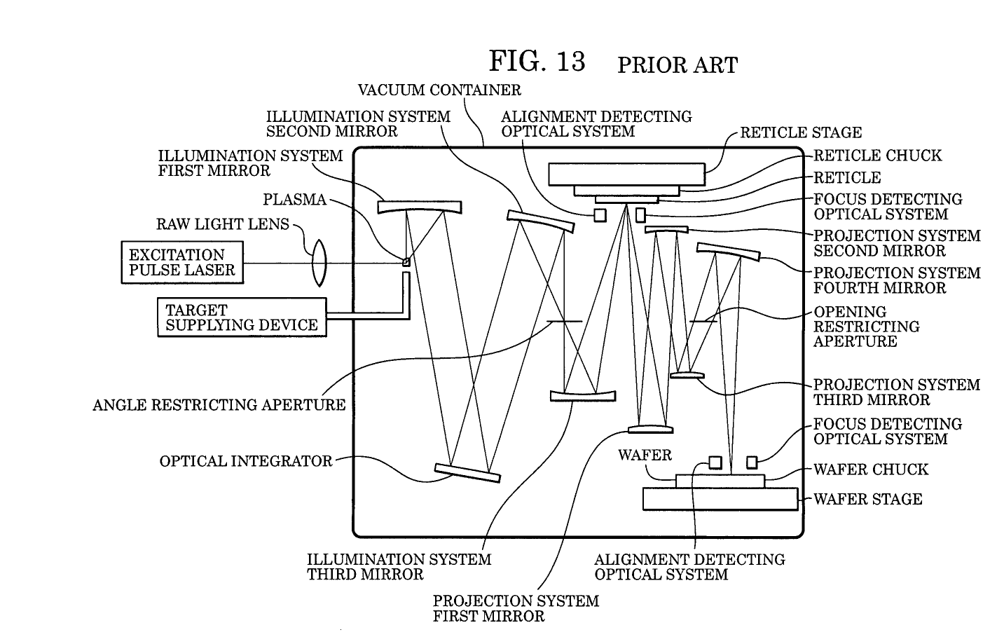

The reference EUV light detecting unit 5-b includes a multilayer mirror 7 having particular incident angle—reflectance properties at a predetermined wavelength such as shown in FIG. 10 for example, a filter 8 with known transmittance, and a photodiode 9 with known quantum efficiency as shown in FIG. 11 for example, i.e., the reference EUV light detecting unit 5-b includes components which are all calibrated, whereby the absolute intensity of incident EUV light can be known. On the other hand, at the EUV light detecting units 5-a and 5-c, measurement of relative intensity is sufficient, so those wherein the incident angle—reflectance properties of the multilayer mirror 7 or wavelength—reflectance properties at a particular incident angle is known are used. With such a configuration, output of the multiple EUV light detecting units 5-a and 5-c is calibrated before measuring the light source.

In step 1, the reference EUV light detecting unit 5-b is moved to a position of the angle (φ0, θ0) in order to confirm the output of the reference EUV light detecting unit 5-b. The beam shutter (hatched portion of 5-b) disposed in front of the reference EUV light detecting unit 5-b is opened prior to irradiating the EUV light. This beam shutter is normally closed during normal EUV light measurement, to prevent soiling of the multilayer mirror, photodiode, and so forth.

Irradiating the EUV light in this state yields the output Q0(φ0, θ0). The output Q0(φ0, θ0) can be expressed as the following Expression:
Q0(φ0, θ0)=G0 Ω∫I(φ0, θ0, λ) R0(λ) T0(λ) S0(λ) dλ (8)
wherein λ represents the wavelength of the light, I(φ0, θ0, λ) represents the intensity of EUV light having the wavelength λ measured at the angle (φ0, θ0), R0(λ) represents the reflectance of the multilayer mirror 7, T0(λ) represents the trasmittivity of the filter 8, S0(λ) represents the quantum efficiency of the photodiode 9, G0 represents the gain of the amplifying circuit (amplifier), and Ω0 represents the solid angle of the EUV light received at the photodiode 9. The measured value Q0(φ0, θ0) is the product of these parameters integrated by the wavelength.

In step 2, the EUV light detection units 5-a are moved to the position of the same angle (φ0, θ0) where the EUV light detection unit 5-b calibrated in Step 1, in order to calibrate the EUV light detection units 5-a No. 1 through No. n. Irradiating the EUV light yields the output Q1(φ0, θ0). The output Q1(φ0, θ0) can be expressed in the following Expression:
Q1(φ0, θ0)=G1 Ω1 ∫I(φ0, θ0, λ) R1(λ) T1(λ) S1(λ) dλ (9)

Also, with G1=aG0, Ω1=bΩ0, T1=cT0, and S1=dS0, Expression (9) can be rewritten as
Q1(φ0, θ0)=aG0 bΩ0 ∫I(φ0, θ0, λ) R1(λ) cT0(λ) dS0(λ) d λ=abcd G0 Ω0 ∫I(φ0, θ0, λ) R1(λ) T0(λ) S0(λ) dλ (10)
With abcd=α1, Expressions (1) and (3) yield
α1=Q1(φ0, θ0)/Q0(φ0, θ0)×(∫I(φ0, θ0, λ) R0(λ) T0(λ) S0(λ) dλ)/(∫I(φ0, θ0, λ) R1(λ) T0(λ) S0(λ) dλ)
The values of Q1(φ0, θ0), Q0(φ0, θ0) can be obtained form this calibration measurement. Also, the other values use pre-calibrated values, thus enabling the sensitivity ratio α1 between the EUV light detection unit 5-a and reference EUV light detection unit 5-b to be obtained.

In step 3, the EUV light detection units 5-a are moved to the position of the angle (φ1, θ1) in order to calibrate the EUV light detection units 5-c. Irradiating the EUV light yields the output Q1′(φ1, θ1).

In step 4, the EUV light detection units 5-c are moved to the position of the same angle (φ1, θ1) as that of the EUV light detection unit 5-b calibrated in Step 3, in order to calibrate the EUV light detection units 5-c No. 1 through No. n. Irradiating the EUV light yields the output Q2′(φ1, θ1), thus enabling the sensitivity ratio between the EUV light detection unit 5-a and EUV light detection units 5-c to be obtained.

The other EUV light detection units 5-a are also handled in the same way, thereby obtaining the sensitivity ratio for each. With regard to the sensitivity ratio α1, there is little effect of the intake solid angle, filter tranmittivity, and photodiode sensitivity, so b, c, and d can be handled as being approximately equal to one another and equal to 1, and difference in output sensitivity can be taken as amplifier gain difference.

Also, in the event of measuring the EUV light source changing over time, such as the spectrum changing over time or the angular distribution of intensity changing over time at the angle (φ0, θ0), either the time for irradiating EUV light is sufficiently extended and the average output thereof is used, or each of the EUV light detecting units 5-a and the reference EUV light detecting unit 5-b are alternately disposed at the angle (φ0, θ0) and measurement is repeated and the average output thereof used, whereby effects of change over time with regard to the EUV light source can be eliminated. Due to this arrangement of the third embodiment wherein a reference EUV light detecting unit is used to calibrate the EUV light detecting units 5-a, and next, the calibrated EUV light detecting units 5-a are used to calibrate the EUV light detecting units 5-c as a reference sensor, the calibration time can be reduced and increased size of the device can be avoided. Also, using parts which have all been calibrated beforehand for the EUV light detecting unit allows not only angular distribution but also absolute quantity of the distribution to be measured.

In this way, calibrating multiple EUV light detecting units with different sensitivity beforehand enables angular distribution to be obtained with higher precision. Also, this calibration can be performed without removing the EUV light detecting units from the device, so change insensitivity of the EUV light detecting units following measurement can be checked.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-044723 filed Feb. 20, 2004, which is hereby incorporated by reference herein.

1. A device operable to measure angular distribution of intensity of EUV light emitted from an EUV light source, the EUV light having a center point of divergence, the device comprising:
a plurality of first EUV light detecting units,
wherein the plurality of first EUV light detecting units are movably disposed at different positions on a substantially spherical plane centered on the center point of divergence of the EUV light so as to allow at least adjacent first EUV light detecting units to detect the EUV light at a substantially same position on the spherical plane.

2. The device according to claim 1, further comprising a second EUV light detecting unit configured to detect the EUV light at a predetermined position, regardless of movement of the plurality of first EUV light detecting units.

3. The device according to claim 2, wherein the second EUV light detecting unit can move outside the flux of the EUV light.

4. The device according to claim 3, wherein each of the first and second EUV light detecting units includes a light reflection mirror and a photoelectric conversion device.

5. The device according to claim 4, wherein the light reflection mirror of the second EUV light detecting unit has an incident light dependency of reflectance at an EUV wavelength band that is known beforehand, and the photoelectric conversion device of the second EUV light detecting unit has a sensitivity property at the EUV wavelength band that is known beforehand.

6. The device according to claim 5, wherein the light reflection mirror of the first EUV light detecting units has an incident light dependency of reflectance at the EUV wavelength band that is known beforehand.

7. An EUV light intensity distribution measuring device operable to measure intensity distribution within an EUV light flux emitted from an EUV light source, the EUV light flux having a center point of divergence, comprising:
a plurality of first EUV light detecting units having an EUV light reflecting mirror and a photoelectric conversion device,
wherein the plurality of first EUV light detecting units are movably disposed at different positions on a substantially spherical plane centered on the center point of divergence of the EUV light flux,
wherein the plurality of first EUV light detecting units includes a first group of first EUV light detecting units movable to a reference position on a substantially spherical plane, and a second group of first EUV light detecting units restricted from moving to the reference position, and
wherein the second group of first EUV light detecting units and at least one of the first EUV light detecting units of the first group are configured to detect the EUV light flux at a substantially same position on the spherical plane.

8. The EUV light intensity distribution measuring device according to claim 7, further comprising a second EUV light detecting unit configured to detect the EUV light flux at a position, regardless of movement of the plurality of first EUV light detecting units.

9. The EUV light intensity distribution measuring device according to claim 8, wherein the second EUV light detecting unit is configured to detect the EUV light flux at a predetermined position.

10. The EUV light intensity distribution measuring device according to claim 8, wherein the second EUV light detecting unit includes an EUV light reflecting mirror and a photoelectric conversion device, and wherein the second EUV light detecting unit is configured to detect the EUV light flux at a reference position on the spherical plane.

11. The EUV light intensity distribution measuring device according to claim 10, wherein the EUV light reflection mirror of the second EUV light detecting unit has an incident light dependency of reflectance at an EUV wavelength band that is known beforehand, and the photoelectric conversion device of the second EUV light detecting unit has a sensitivity property at the EUV wavelength band that is known beforehand.

12. The EUV light intensity distribution measuring device according to claim 8, wherein the second EUV light detecting unit can move outside the EUV light flux.

13. The EUV light intensity distribution measuring device according to claim 8, wherein the EUV light reflection mirror of the first EUV light detecting units has an incident light dependency of reflectance at the EUV wavelength band that is known beforehand.

14. An EUV light intensity distribution measuring device operable to measure intensity distribution within an EUV light flux emitted from an EUV light source, the EUV light flux having a center point of divergence, comprising:
a plurality of first EUV light detecting units having an EUV light reflecting mirror and a photoelectric conversion device,
wherein the plurality of first EUV light detecting units are movably disposed at different positions on a substantially spherical plane centered on the center point of divergence of the EUV light flux, and
wherein the plurality of first EUV light detecting units are configured to move to a reference position on the spherical plane.

15. The EUV light intensity distribution measuring device according to claim 14, further comprising a second EUV light detecting unit configured to detect the EUV light flux at a position, regardless of movement of the plurality of first EUV light detecting units.

16. An EUV light intensity distribution measuring method in the device according to claim 2, the method comprising:
calibrating the EUV light detection intensity of each of the plurality of first EUV light detecting units by measuring beforehand at least one of a sensitivity ratio between the plurality of first EUV light detecting units, and a sensitivity ratio between the second EUV light detecting unit and each of the plurality of first EUV light detecting units.

17. An EUV light intensity distribution measuring method in the device according to claim 8, the method comprising:
calibrating the EUV light detection intensity of each of the plurality of first EUV light detecting units by measuring beforehand at least one of a sensitivity ratio between the plurality of first EUV light detecting units, and a sensitivity ratio between the second EUV light detecting unit and each of the plurality of first EUV light detecting units.

18. An EUV light intensity distribution measuring method in the device according to claim 15, the method comprising:
calibrating the EUV light detection intensity of each of the plurality of first EUV light detecting units by measuring beforehand at least one of a sensitivity ratio between the plurality of first EUV light detecting units, and a sensitivity ratio between the second EUV light detecting unit and each of the plurality of first EUV light detecting units.
